(19) United States
(12) Patent Application Publication
(10) Pub. No.: US 2011/0181711 A1
(43) Pub. Date: Jul. 28, 2011

(54) SEQUENTIAL IMAGE GENERATION

(76) Inventor: Luke Reid, Dunedin (NZ)

(21) Appl. No.: 12/935,876

(22) PCT Filed: Apr. 1, 2009
(86) PCT No.: PCT/EP2009/053869

§ 371 Date: Apr. 14, 2011

(30) Foreign Application Priority Data
Apr. 1, 2008 (GB) 0805856.2

(51) Int. Cl. H04N 7/18

(52) U.S. Cl. 348/121; 348/E07.085

(57) ABSTRACT

A method of generating sequential images representing an object under user control within a virtual environment, the method comprising accessing a set of scenic images which each represent at least part of said virtual environment as viewed from known viewpoints, and during sequential image generation:
receiving user commands;
maintaining object position variable data representing a current object position within said virtual environment, which is updated in response to said user commands;
selecting scenic images to be accessed according to a current viewpoint determinant;
overlaying a generated object image onto a selected scenic image according to the current object position.

### CROSS-REFERENCE TO RELATED APPLICATIONS

This application is a continuation of, and claims the benefit of the filing date of, co-pending international patent application no. PCT/EP2009/053869, designating the United States of America, entitled SEQUENTIAL IMAGE GENERATION, filed Apr. 1, 2009, which claims priority to British patent application no. GB 0805856.2, entitled SEQUENTIAL IMAGE GENERATION, filed Apr. 1, 2008.

### FIELD OF THE INVENTION

The present invention relates to capturing image data and subsequently generating sequential images representing movement of an object under user control.

### BACKGROUND OF THE INVENTION

Traditional motion picture image capture and playback uses a motion picture camera which captures images in the form of a series of image frames, commonly referred to as footage, which is then stored as playback frames and played back in the same sequence in which they are captured. A motion picture camera may be either a film camera or a video camera (including digital video cameras). Furthermore the sequence of image frames may be stored as a video signal, and the resulting motion pictures may be edited or unedited motion picture sequences which are used for motion picture film, TV, computer graphics, or other playback channels. Whilst developments in recording and playback technology allow the frames to be accessed separately, and in a non-sequential order, the main mode of playback is sequential, in the order in which they are recorded and/or edited. In terms of accessing frames in non-sequential order, interactive video techniques have been developed, and in optical recording technology, it is possible to view selected frames distributed through the body of the content, in a preview function. This is, however, a subsidiary function which supports the main function of playing back the frames in the order in which they are captured and/or edited.

The development and playback of interactive computer applications with real-time graphics, such as computer video games, rely on game engines providing a flexible and reusable software platform on which the interactive applications are developed and played back. A plurality of different components, offering different functionality, are required of game engines to generate realistic interactive virtual environments. Typically the functionality offered by a “game engine” may comprise the following components: a rendering engine for 2D or 3D graphics; a physics engine or collision detection to realistically simulate interaction with objects within the virtual scene; an audio engine; an animation engine to animate synthetically generated objects; a scripting engine; an artificial intelligence engine to simulate intelligence in non-player characters; and other components which may include components controlling the allocation of hardware resources. It is common for the component-based architecture of game engines to be designed offering the flexibility of replacing or extending the functionality of components with specialised stand-alone 3^{rd} party applications dedicated to performing specific tasks. For example it is common that the creation and rendering of synthetic 3D object models appearing in a virtual environment are generated using dedicated stand-alone 3^{rd} party applications such as Maya® or 3ds Max®. In such scenarios the game engine, often referred to as middleware, provides a platform whereby the varied functionality offered by the plurality of different stand-alone 3^{rd} party applications may be used together.

The increase in hardware performance of computers and the growing consumer demand for ever more realistic and sophisticated computer generated virtual environments with real-time graphics has resulted in developers allocating ever larger financial resources to developing complex game engines. The use of game engines is not restricted to computer video game development, the majority of interactive applications requiring real-time graphics are developed using game engines such as, but not restricted to, marketing demos, architectural visualisations, training simulations and modelling environments.

Typically computer-generated virtual environments are generated from a three dimensional (3D) representation of the environment, typically in the form of an object model, and by then applying geometry, viewpoint, texture and lighting information. Image rendering of the virtual environment may be conducted non-real time, in which case it is referred to as pre-rendering, or in real time. Pre-rendering is a computationally intensive process that is typically used in motion picture films requiring computer generated imagery, whilst real-time rendering is used, for example in simulators or computer video games requiring real-time graphics generation. The processing demands of rendering real-time graphics and the demand for highly sophisticated graphics, has resulted in specially designed hardware equipment, such as graphics cards with 3D hardware accelerators, to be included as a standard in commercially available personal computers, thereby reducing the work load of the CPU. Such specialised hardware deals exclusively with the processing of graphical data. As computer-generated graphics become ever more sophisticated and computer-generated virtual scenes become more realistic, the processing demands will increase dramatically.

Generating a 3D object model for a computer-generated virtual environment has always been relatively intensive, particularly when photorealistic or complex stylised scenes are desired, typically involving a very large number of man hours of work by highly experienced programmers and artists. The increasing demand for photorealistic computer generated graphics has resulted in spirally increasing development costs for simulators, computer video games, computer generated imagery for motion picture films and other applications relying on computer-generated graphics. The increased man-hours required to develop such highly stylised and sophisticated computer-generated graphics is particularly disadvantageous when time-to-market is important.

It is an objective of the present invention to improve, simplify and reduce the development costs of computer generated photorealistic graphics.

### SUMMARY OF THE INVENTION

The present invention is set out in the appended claims.

The present invention provides a method of generating sequential images representing an object under user control within a virtual environment, the method comprising accessing a set of scenic images each representing at least part of the virtual environment as viewed from known viewpoints, and during sequential image generation:

receiving user commands;

maintaining object position variable data representing a current object position within the virtual environment, which is updated in response to aforementioned user commands;

selecting scenic images to be accessed according to a current viewpoint determinant;

overlaying the generated object image onto a selected scenic image according to the current object position.

Embodiments of the invention comprise maintaining current viewpoint variable data, which is updated in response to the user commands, the viewpoint determinant being based upon the current viewpoint variable data.

An advantage of the invention is that highly stylised and/or photorealistic graphics, for use in generating virtual environments, can be generated at a fraction of the cost and time required for conventional graphics generation relying on object models of the virtual environments, whilst computer-generated objects, under the control of the user, can be located in the scene according to the current viewpoint determinant and the current object position.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows apparatus used for sequential image generation and playback in accordance with a preferred embodiment of the present invention.

FIG. 2 shows a perspective view of apparatus used for capturing scenic images according to an embodiment of the invention.

FIG. 3 shows a plan view of a capture path followed to capture scenic images according to an embodiment of the invention.

FIG. 4 shows a captured scenic image according to an embodiment of the invention.

FIG. 5 shows a flow diagram of a method of processing captured scenic images according to an embodiment of the invention.

FIG. 6 shows a visual representation of a method of associating captured scenic images to a DEM.

FIG. 7 shows a flow diagram of a method of maintaining object position variable data.

FIG. 8 shows a plan view of a plurality of scenic images and the motion path of a moving object on a DEM in accordance with an embodiment of the present invention.

FIG. 9 shows a flow diagram of a method of generating a sequential image in accordance with an embodiment of the invention.

FIG. 10 shows a perspective view of a method using ray tracing to render a sequential image in accordance with an embodiment of the invention.

FIG. 11 shows a flow diagram of a playback method in accordance with an embodiment of the invention.

### DETAILED DESCRIPTION OF THE INVENTION

The invention provides for a method of generating sequential images for playback, representing motion of an object under user control within a virtual environment. The object may be either two dimensional (2D) or three dimensional (3D) and may be synthetically generated. The method includes tracking the object's position variable data indicative of the object's movement through the virtual environment in response to received user commands. Scenic images of a real physical environment are accessed and selected according to a current viewpoint determinant, and the selected scenic images are overlaid with a perspective image of the object on the basis of the object's position variable data. Received user commands may also be used to maintain current viewpoint variable data on the basis of which the current viewpoint determinant determines the current viewpoint. Scenic images are selected according to the determined viewpoint. The received user commands may be used to maintain both current object position variable data and current viewpoint variable data.

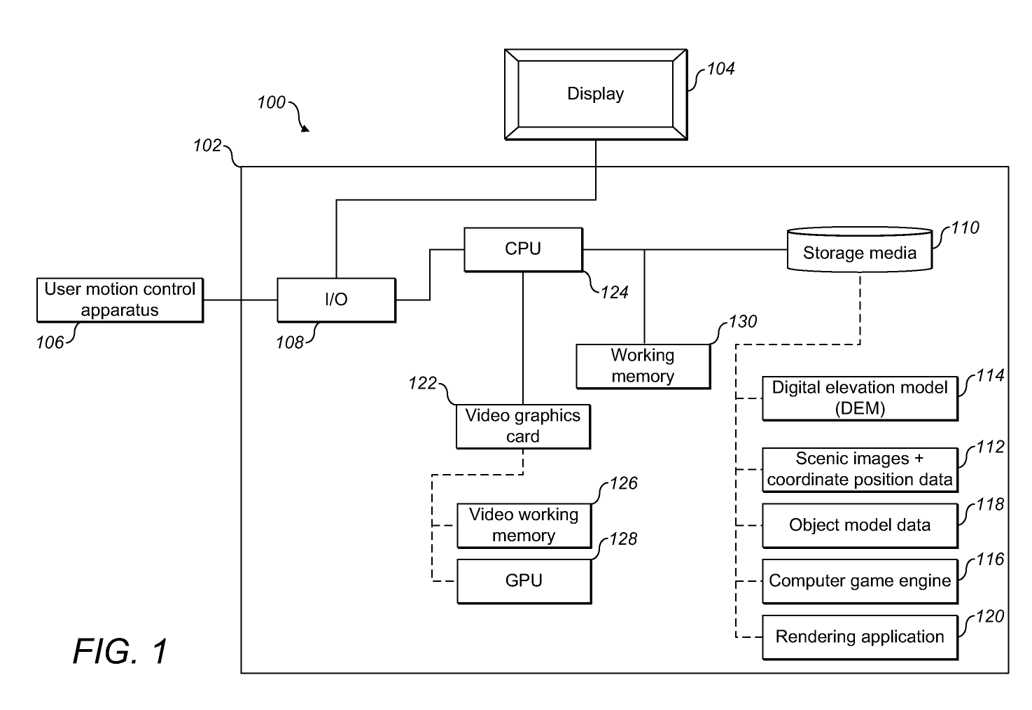

FIG. 1 illustrates the apparatus 100 used in accordance with a preferred embodiment of the current invention. A computer 102 has attached display 104 for displaying a generated sequence of images during playback, and a user motion control apparatus 106, which in preferred embodiments may be a joystick or other such control apparatus, for generating user commands to control movement of the object within the virtual environment. Furthermore the received user commands may be used to maintain current viewpoint variable data, which in preferred embodiments may include data relating to the viewpoint position, orientation, rate of change of position, to name but a few examples. Both the display 104 and the user motion control apparatus 106 are connected to an I/O (Input/Output) 108 of the computer 102. A storage medium 110 contains a set of scenic images 112 of a real physical environment with associated coordinate position data, including coordinate position data of the viewpoint and may also include coordinate position data of the area of the real physical environment imaged in a single captured scenic image. The area of the real physical environment imaged in a single scenic image selected from the set of scenic images 112 may be related to the corresponding area on the digital elevation model (DEM) map 114 of the real physical environment being virtually reproduced. The DEM 114 is a digital representation of the ground surface topography of the selected physical environment and is often commonly referred to as a digital terrain model (DTM). The elevation of the terrain is continuously defined on DEM 114—each point on the DEM 114 has a defined positional coordinate. The DEM 114 of the real physical environment is stored on storage media 110. A computer game engine 116, also commonly referred to as “middleware”, is stored on the storage media 110. In preferred embodiments the game engine 116 is comprised of the following components: a rendering engine for 2D or 3D images; a physics engine or collision detection; an audio engine; an animation engine; a scripting engine; an artificial intelligence engine; and other components controlling allocation of hardware resources of computer hardware 102 by the game engine 116. As previously stated the different components of a game engine 116 may be replaced by stand-alone 3^{rd} party applications, in which case the game engine 116 acts as middleware allowing the functionality offered by the plurality of different 3^{rd} party applications to be merged together in a common application. For example it is common that one or more 3^{rd} party stand-alone applications are used to generate object models and to render images thereof. In FIG. 1 it is to be understood that the game engine 116 may have inbuilt components offering the functionality for generating object model data 118 and rendering images thereof. Object model data 118 defines the object and all its characteristics. Alternatively the functionality of generating object model data 118 is offered by one or more stand-alone 3^{rd} party applications, such as rendering application 120, which could be Maya® or 3ds Max® in alternative embodiments of the present invention. It is also envisaged and falls within the scope of the present invention, that other 3^{rd} party applications not mentioned herein may be used in conjunction with game engine 116. In such embodiments where a plurality of different 3^{rd} party applications are used to provide the functionality required of game engine 116 for the purposes of generating interactive applications with real-time graphics, the role of the game engine 116 is to allow the functionality offered by the plurality of different 3^{rd} party applications to be used together coherently for a common application. For present purposes both embodiments are envisaged and fall within the scope of the current invention. Rendering application 120 is an example of a stand-alone 3^{rd} party application. Object model data 118 of an object is stored on storage media 110 and used to overlay a perspective image of the object on a scenic image selected from the set of scenic images 112. In preferred embodiments computer 102 includes a video graphics card 122 connected to CPU 124. The video graphics card 122 comprises a video working memory 126 and a graphics processing unit (GPU) 128. Video graphics card 122 reduces the processing workload on CPU 124 by monopolising the processing of graphics related data. In alternative embodiments of the current invention it is envisaged that no video graphics card 122 is present in which case CPU 124 is responsible for processing all graphics related data. Alternatively it is envisaged that any other processor, distinct from CPU 124 and GPU 128, processes the graphics related data.

In a preferred embodiment of the present invention user commands in the form of object motion control data generated by the user motion control apparatus 106 are processed by CPU 124 in working memory 130 and used to define current object position variable data of the object model, which may be related to data points on the DEM 114. Using the defined current object position variable data a scenic image is selected from the set of scenic images 112 stored on storage media 110 on the basis of a current viewpoint determinant. In preferred embodiments the current viewpoint determinant may be a predetermined algorithm which determines the current viewpoint position according to the object position variable data, and consequently a scenic image from the plurality of scenic images 112 is selected on the basis of the determined current viewpoint position. The determined current viewpoint position corresponds to the viewpoint of the selected scenic image. In certain embodiments the current viewpoint determinant may determine the current viewpoint position on the basis of proximity to the object position variable data, and accordingly the scenic image with the determined viewpoint is selected. In such an embodiment the distance of the object model, as defined by the object position variable data, from the plurality of viewpoint positions may be continuously calculated by CPU 124 as the object moves in the virtual environment. The viewpoint and accordingly the scenic image having the shortest distance to the object position variable data is selected. It is envisaged that the current viewpoint determinant may determine the current viewpoint, and hence the scenic image from the set of scenic images 112, according to alternate algorithms, and such alternative embodiments fall within the scope of the current invention.

In an alternative embodiment of the present invention it is envisaged that both current object position variable data and current viewpoint variable data are maintained on the basis of received user commands from user motion control apparatus 106. The current viewpoint determinant determines the current viewpoint on the basis of current viewpoint variable data which is itself updated in response to received user commands. A scenic image is selected to be overlaid with a perspective image of the object on the basis of the determined viewpoint. The algorithm employed by the current viewpoint determinant to determine a current viewpoint in such embodiments may vary on the basis of the current viewpoint variable data. The relationship between current object position variable data and selected scenic image is variable. Such embodiments may be used to simulate a plurality of effects, such as inertial effects. For example if the object accelerates at a particular rate, as defined by received user commands, resulting in a corresponding rate of change of object position variable data, the current viewpoint determinant may determine a viewpoint whose position is further from the object (as defined by its object position variable data) as it would select if the object was moving at a constant speed. In such embodiments the current viewpoint determinant may vary how the current viewpoint is determined, and hence how the scenic image is selected, dependent on the current viewpoint variable data. Current viewpoint variable data includes data relevant to the viewpoint such as, but not exclusively: viewpoint position data and rate of change of viewpoint position data to list but a few. In certain embodiments the current viewpoint variable data could be related to the current object position variable data.

The object position variable data, representative of the position of the object may be related to positions on the DEM 114, as can the area imaged by scenic images 112. In a preferred embodiment the object position variable data may be position coordinate data expressed using the same coordinate system as the DEM 114. Using the object position variable data and the scenic image selected from the plurality of scenic images 112 in accordance with the current viewpoint determinant, the CPU 124 may calculate the relative position of the object with respect to the determined viewpoint position (corresponding to the viewpoint of the selected scenic image). In particular the orientation and position of the object with respect to the determined viewpoint position are calculated by CPU 124. The calculated position and orientation data of the object with respect to the determined viewpoint position is used by rendering application 120 to render the correct perspective image of the object to be overlaid on the selected scenic image. In an alternative embodiment the GPU 128 of the video graphics card 122 calculates the relative position and orientation data of the object with respect to the determined viewpoint position. The perspective image of the object is rendered by game engine 116 and relevant data is processed by video graphics card 122, by loading video working memory 126 with the calculated position and orientation data, and the object model data 118. The GPU 128 processes the calculated position and orientation data, and the object model data 118 to render the perspective image of the object that would be observed from the selected scenic image viewpoint. The rendered perspective image of the object is overlaid on the selected scenic image, at an image position in accordance with the object position variable data. In embodiments of the current invention the rendering process may use ray tracing methods to generate the perspective image of the object and to overlay the perspective image at the correct image position on the selected scenic image. The complete rendered image, consisting of selected scenic image with overlaid rendered perspective image of the object, is forwarded to display unit 104 for display during playback. This process is repeated for selected scenic images contained in the set of scenic images 112 as the object position variable data is updated in accordance with received user commands generated by user motion control apparatus 106, thereby generating sequential images representing a moving object under user control within a virtual environment. The impression of speed is conveyed by varying the rate at which generated sequential images are played back in accordance with received user commands. A plurality of variables known in the art, may be taken into consideration to improve the photorealism of the generated sequential images, such as lighting effects and motion blur to name but a few. The advantages of using scenic images 112 of a real physical environment as the background scenic images in a virtual environment are at least two-fold: the time consuming process of creating complex object models of the environment is reduced, as is the associated cost; the photorealism of the rendered scene is higher than the conventional method of rendering scenic images from generated environment models and is dependent on the resolution of captured scenic images 112. DEM 114 provides a convenient means of tracking motion of an object in the virtual environment and accordingly selecting scenic images from the set of scenic images 112.

In preferred embodiments of the present invention scenic images 112 are captured in a time sequential order and may be played back in the same time sequential order with an overlaid perspective image of an object, thereby generating sequential images representing motion of an object under user control in a virtual environment. Motion is simulated by repositioning the object in successive scenic images and by varying the speed of playback of the generated sequential images.

Some important details of the method of the present invention will be discussed in the following sections including: the method of data capture and data processing; tracking object position using object position variable data according; image rendering and playback, all in accordance with preferred embodiments of the present invention.

### Data Capture

Scenic images 112 of a real physical environment are captured using an image capture device, which in preferred embodiments may be a video camera or a photographic camera. The motion of the image capture device is recorded using a position tracking device, in preferred embodiments this may be GPS apparatus, such that the viewpoint positions of captured scenic images 112 are known and may be related to points on DEM 114.

In preferred embodiments of the invention a desired physical environment is selected to be virtually reproduced, and the corresponding DEM 114 of the physical environment is selected. A vehicle is mounted with an image and position capture device, continuously capturing both scenic images 112 of the physical environment and coordinate position data as the moving vehicle traverses the physical environment. The captured coordinate position data may refer directly to the position of the image capture device in preferred embodiments, or in alternative embodiments the captured coordinate position data refers to the position of a point on the moving vehicle, in which case the coordinate position data of the image capture device must be derived therefrom. The position capture device is configured such that any change of position with respect to the 6 degrees of freedom is measurable. The 6 degrees of freedom being any movement along the x, y and z-axis, as well as rotations about any one of these axis, i.e. roll, tilt and yaw (ρ, θ, φ). The image capture device may be a video camera or a photographic camera with known imaging characteristics, and could have a wide-angle lens. In preferred embodiments the position capture device may be an RTK-GPS (Real Time Kinematic GPS) receiver or a differential GPS (DGPS) receiver, each having the advantage of providing more accurate position data than a conventional GPS receiver. Preferably a plurality of GPS/RTK-GPS/DGPS receivers are distributed throughout the moving vehicle, arranged in such a way that a displacement along any one of the 6 degrees of freedom of the vehicle may be measured directly or derived from the receivers' readings. In the embodiment where RTK-GPS is used, in addition to the plurality of RTK-GPS receivers placed on the moving vehicle one or more base stations may be placed on known surveyed points in the physical environment being captured. The base stations transmit signal corrections to the RTK-GPS receivers, greatly improving the accuracy of the receiver's positional readings and thereby improving the accuracy of the measured coordinate position data of the moving vehicle. Commercially available RTK-GPS systems are known to have an accuracy of 1 cm+/−2 parts-per-million horizontally and 2 cm+/−2 parts-per-million vertically.

In an alternative embodiment a GPS receiver together with an inertial navigation system (INS) is used to record the coordinate position data of the image capture device as the moving vehicle traverses the real physical environment. In such embodiments the GPS provides the coordinate position data whilst the INS provides the orientation data, or rather the rotational data (ρ, θ, φ), i.e. roll, tilt and yaw. Alternatively, dependent on the selected INS, no GPS receiver is required, as the INS may have an in-built functionality to measure orientation data, velocity data and position data simultaneously.

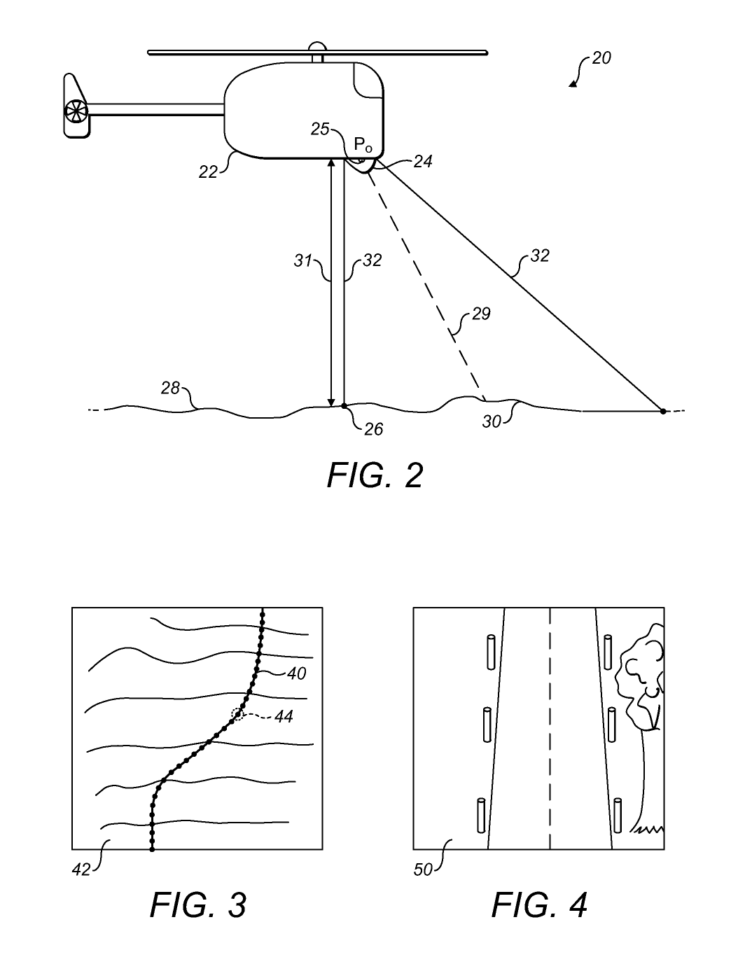

In a preferred embodiment of the present invention the moving vehicle is a helicopter configured with an image capture device and one or more position capture devices, such as previously described, distributed throughout the helicopter such that accurate coordinate position data of the image capture device, including roll, tilt and yaw (ρ, θ, φ), may be calculated. FIG. 2 illustrates a preferred embodiment of the capture apparatus 20 used in accordance with the present invention, wherein a helicopter 22 is equipped with an image capture device 24, and illustrates one scenic image being captured. One or more position capture devices (not illustrated in FIG. 1) are distributed such that the coordinate position data including roll, tilt and yaw of the image capture device may be defined, whose position is labelled P₀ 25 in FIG. 2. The projection 26 of the image capture position P₀ 25 onto the physical terrain 28 may be found by identifying the point P 26 on the DEM 114 sharing the same longitudinal (which could be the x coordinate if so defined) and latitudinal (which could be the y coordinate if so defined) coordinates with P₀ 25. The height 31 of the helicopter above the physical terrain 28 may be calculated by comparison of the altitude coordinates (which could be the z coordinate if so defined) of points P₀ 25 and P 26. In certain embodiments the orientation and the position of the image capture device is fixed with respect to the helicopter, the image capture device's coordinate position data (x, y, z, ρ, θ, φ) may be calculated from the coordinate readings of the one or more position capture devices defining the helicopter's position, knowing the physical dimensions of the helicopter and the relative position of the image capture device with respect to the one or more position capture devices. The optical axis 29 of the image capture device may be used to define the image capture device's roll, tilt and yaw which also define the image capture device's orientation. The helicopter 22 flies over the physical terrain 28, of the physical environment, continuously capturing scenic images 112 of portions 30 of the physical terrain 28. The area of terrain portion 30 captured by the image capture device 24 may be calculated knowing the imaging characteristics (such as the horizontal and vertical field of view) of the image capture device 24 and the height 31 of the image capture device 24 above the physical terrain 28 at the time of image capture. The light rays 32 represent the extremum light rays captured by the image capture device 24, and trace out a volume which may be referred to as a light cone. In FIG. 2 the rays 32 illustrate a cross sectional view of such a light cone, depicting the boundaries thereof. The boundaries of the light cone captured may be found from the known vertical and horizontal fields of view of the image capture device 24. Any point falling within the boundaries of rays 32, and hence within the light cone, is imaged by image capture device 24.

The image capture path of the image capture device 24 may be traced out on the DEM 114 of the physical environment as illustrated in FIG. 3. Capture path 40 of the image capture device 24 is depicted on DEM 42 and is composed of a plurality of viewpoint positions 44 corresponding to the position at which scenic images 112 of the physical environment were captured. A number of different methods may be employed to associate specific coordinate position data to a specific captured scenic image. In preferred embodiments a time stamp may be added to each captured scenic image using synchronised clocks placed within the image capture device 24 and the position measuring device. Specific coordinate position data may be associated to each captured scenic image by comparing the position measuring device's time readings with the time stamps of the captured scenic images 112. In such embodiments it is envisaged that one uses a 7 dimensional coordinate system to define the captured scenic images 112, 6 positional (x, y, z, ρ, θ, φ) and one temporal. Alternatively it is envisaged that a data connection between the one or more position measuring devices and the image capture device 24 is established, such that coordinate position data is recorded simultaneously with every captured scenic image. Other methods, not detailed herein, of associating coordinate position data to captured scenic images 112 are envisioned, and fall within the scope of the present invention.

FIG. 4 illustrates an example of a scenic image 50 captured from a viewpoint position 44. The perspective of the captured scenic image 50 is determined by the position and orientation of the image capture device 24 at the time of scenic image capture.

In embodiments where the DEM 114 is considered too coarse, the DEM data 114 may be complimented by sampling the elevation of the physical terrain with a coordinate position measuring device. In a preferred embodiment a mobile RTK-GPS receiver is used to sample portions of terrain which are of particular interest, and correspond to those terrain portions whose scenic image has been captured. The newly captured position data is subsequently added to the DEM 114. The mobile RTK-GPS receiver is mounted on a moving vehicle, such as an automobile or other such moving vehicle and position coordinate data is sampled at regular intervals as the physical terrain is traversed. The shorter the sampling intervals, the greater the accuracy of the derived terrain topography. A mobile RTK-GPS receiver allows a large area of terrain to be sampled in a relatively short time period.

The method of scenic image capture employed in accordance with the current invention allows scenic images 112 of a real physical environment to be captured in a relatively short period of time. It is possible by employing the method described herein to capture all required scenic images 112 to reproduce a virtual environment in a number of hours.

During playback the frame rate is preferably at least 30 frames per second. The spacing of the points of image capture in the real physical scene correspond to the spacing of the viewpoint positions 44, and are determined not by the frame rate but by the rate at which the human brain is capable of detecting changes in a moving image, referred to as the image rate. Preferably, at least at some points in time during image generation, the image rate is less than the frame rate, and preferably less than 20 Hz. The spacing of the points of image capture and consequently the viewpoint position spacing is determined by the fact that the human brain only processes up to 14 changes in images per second, while it processes ‘flicker’ rates up to 70-80 Hz. The display is updated regularly, at the frame rate, but the image only needs to really change at about 14 Hz. The viewpoint position spacing is determined by the speed in meters per second, divided by the selected rate of change of the image—the image rate. For instance at a walking speed of 1.6 m/s images are captured around every 114 mm to create a fluid playback. For a driving game this might be one every meter (note that the calculation must be done for the slowest speed one moves in the simulation). Conventional image capture devices such as commercial video camera devices have a fixed image capture frequency—the number of images captured per unit time is constant. In a preferred embodiment of the present invention the image capture device 24 has a variable image capture frequency to compensate for the varying speed of the moving vehicle 22 on which the image capture device 24 is mounted. As the moving vehicle's 22 speed changes so too must the rate at which the image capture device captures scenic images 112 if the distance between adjacent positions of capture and hence the viewpoint spacing of adjacent scenic images 112 is to remain constant, thereby ensuring that the minimum image rate is at least 14 Hz. This ensures a fluid playback of the sequence of images at the minimum playback speed. By varying the frequency of image capture proportionately to the speed of the moving vehicle, ensures that the minimum image rate, which is preferably at least 14 Hz, is maintained during minimum playback speed. Controlling the frequency of image capture is especially important when capturing scenic images 112 from faster moving vehicles such as a helicopter, where large distances of the real physical environment are covered in a relatively short period of time, furthermore moving vehicles are subject to accelerations and are unlikely to maintain a constant speed—such realities must be compensated for. In an alternative embodiment more scenic images 112 per unit distance are captured than required to satisfy the minimum speed of playback requirement, as this has a reduced detrimental impact on the fluidity of the played back sequence of images. However, capturing too few scenic images 112 over a given unit of distance can have a detrimental impact on the fluidity of the image sequence when played-back at the minimum playback speed, as the transition between adjacent scenic images 112 of the image sequence will not appear smooth.

### Processing Captured Data

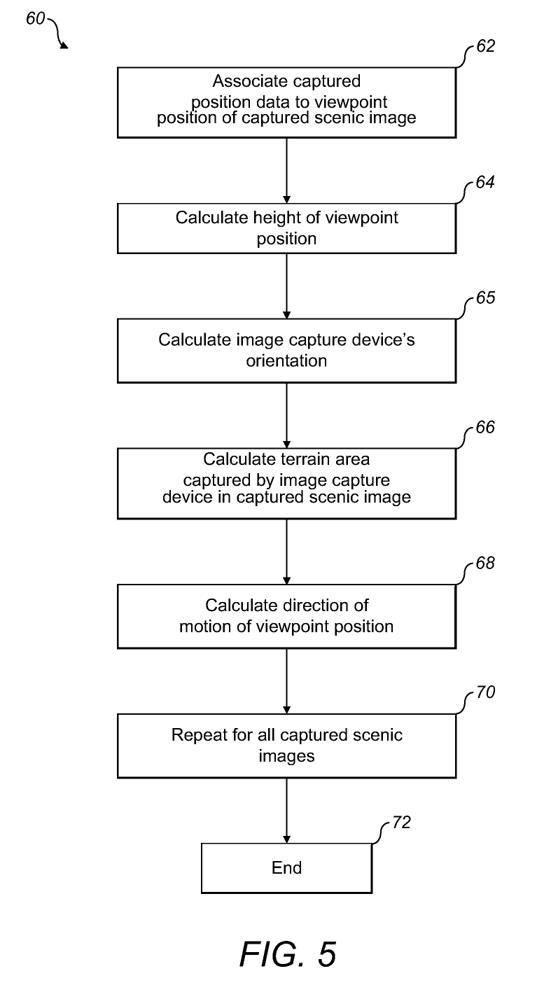

FIG. 5 is a process flow chart 60 illustrating how data is derived from captured scenic images 112 and coordinate position data, in accordance with a preferred embodiment of the invention. The captured coordinate position data is associated to the viewpoint position of the captured scenic image 62. In certain embodiments this may be achieved by comparing time stamps of the captured scenic images and the coordinate position data. The height of the viewpoint position above the physical terrain is calculated 64 by comparison of the viewpoint coordinate position data with DEM data 114. The orientation of image capture device 24 is calculated 65. In preferred embodiments the orientation of the image capture device 24 is fixed with respect to the moving vehicle 22. It is convenient to define the orientation of the image capture device 24 as the direction of the optic axis 29 with respect to the position of the moving vehicle 22. Alternatively the orientation of the optic axis 29 may be calculated using ray tracing techniques, knowing that the optic axis 29 bisects the horizontal and vertical field of view of the image capture device 24. In alternative embodiments the orientation of the image capture device 24 may be variable with respect to the moving vehicle 22. In such embodiments it is envisaged that the image capture device 24 may be mounted on a servo device (not pictured in FIG. 2) allowing the image capture device 24 to rotate, such that the orientation of the optic axis 29 may be selectively varied. In such embodiments the start orientation of the optic axis 29 with respect to the moving vehicle 22 is recorded and subsequent orientations are calculated by analysing servo control data used to rotate the image capture device 24. Alternatively the orientation of the optic axis 29 may be calculated using ray tracing techniques as previously mentioned. The area of the real physical environment captured by the image capture device 24 in the captured scenic image is calculated 66. In a preferred embodiment the area captured by the image capture device may be calculated using aforementioned ray tracing techniques. The viewpoint height, position and orientation of the optic axis 29, along with knowledge of the imaging characteristics of the image capture device 24 such as focal length, field of view, numerical aperture and possibly other imaging characteristics of the image capture device 24 may be used to backwards trace light rays from the image plane of the image capture device 24 to points on the DEM 114 and vice versa. These calculations may be conducted in non-real time ensuring very high accuracy. The direction of motion of the viewpoint position 25 is calculated 68 by comparing the coordinate position data of adjacent viewpoints 44. The above described calculations are repeated for all captured scenic images 70 and the calculated data is stored with the associated scenic images 112 on an appropriate storage medium 110 after which the process is ended 72.

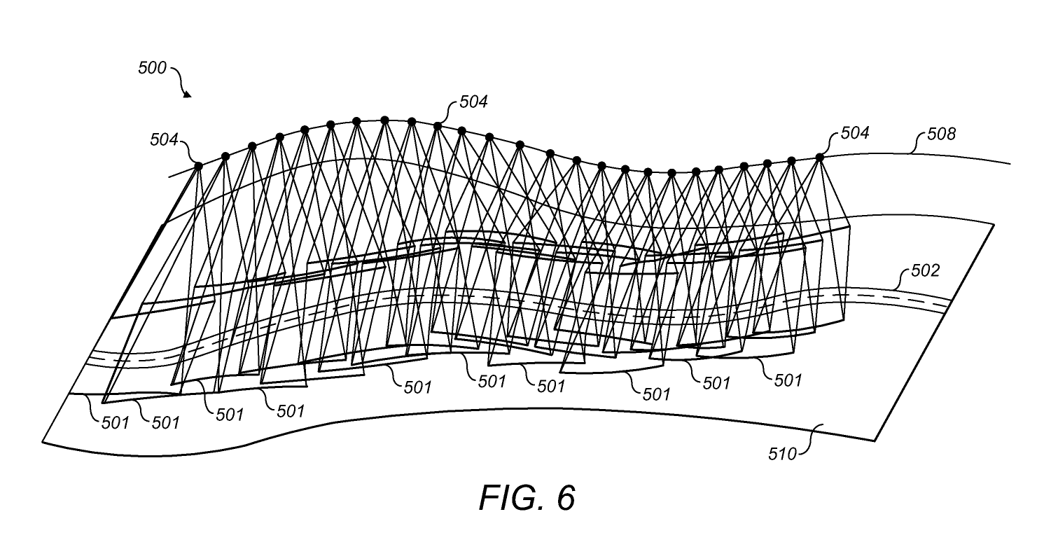

FIG. 6 is a visual representation 500 of the method used according to the current invention. A helicopter (not illustrated) with an image capture device 24 as previously described captures scenic images 501 of a road 502 at a plurality of positions of capture 504. The plurality of positions of capture 504, correspond to the viewpoint positions of the scenic images 501 captured at the positions of capture 504. Scenic images 501 represent images of portions of the physical terrain containing road 502. The locus of the plurality of positions of capture 504 traces out the capture path 508 of the image capture device (not pictured) and accordingly the viewpoint path. Once the terrain area captured by the scenic images 501, as described in step 66 of FIG. 5, has been calculated, the captured scenic images 501 may be related to areas on the DEM 510. The viewpoint positions of the plurality of captured scenic images 501 and the terrain area captured by each scenic image 501 may be related to the DEM 510. In a preferred embodiment the method of the current invention may be used to track the position of a moving object on the DEM 510 using the object position variable data and determining the current viewpoint, on the basis of which selecting the appropriate scenic image from the plurality of scenic images 501 to overlay with the perspective image of the object.

In an alternative embodiment both the object position variable data and the current viewpoint variable data may be tracked on the DEM 510. The current viewpoint determinant determining the current viewpoint on the basis of the current viewpoint variable data. The determined viewpoint is then used to select a scenic image from the plurality of scenic images 501 to overlay with the perspective image of the object.

### Tracking Object Position

The movement of an object in the computer generated virtual environment is tracked using the DEM 114 of the corresponding real physical environment.

The object position variable data is data indicative of the position of the object and may vary in response to user commands received via the user motion control apparatus 106 (FIG. 1). In a preferred embodiment the position of the object is defined on the DEM 114. As user commands are received the position of the object on the DEM 114 is updated in accordance with the received user commands.

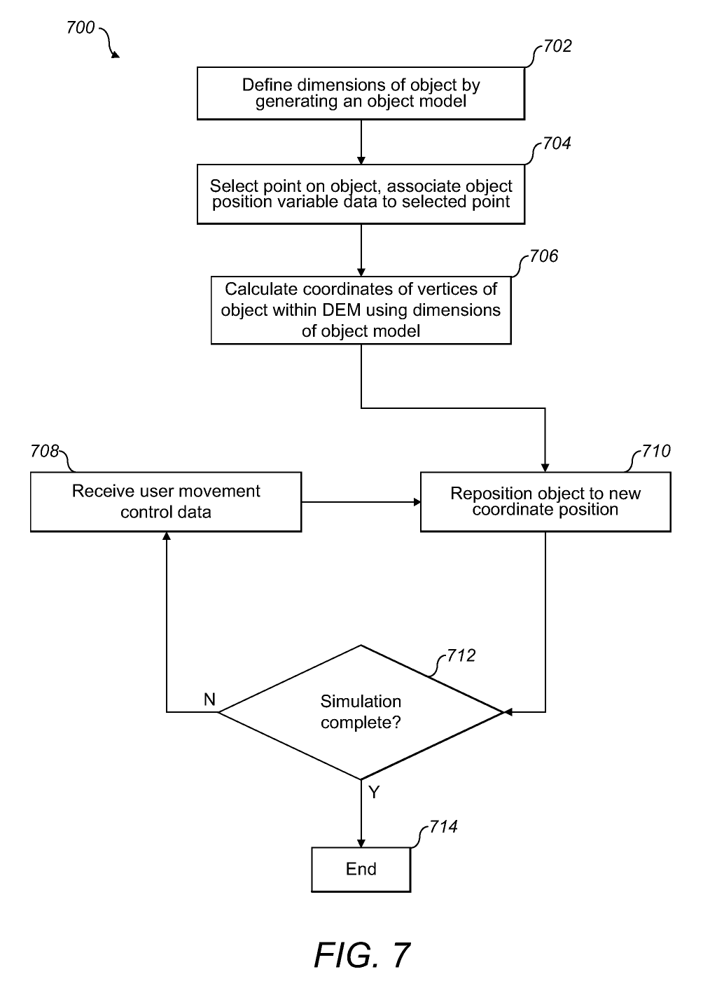

FIG. 7 is a flow chart describing a method 700 in accordance with preferred embodiments of the current invention for tracking the motion of the object within the virtual environment. The dimensions of the object are defined 702, by creating an object model. In a preferred embodiment this may involve generating a polygon model of the object either using the game engine 116, should the game engine 116 have the in-built functionality, or alternatively using a 3^{rd} party stand-alone application. It is common that rendering applications such as 120 (FIG. 1) have a function for generating polygon models of objects. In a preferred embodiment a tracking point is selected on the object and used to track the motion of the object on the DEM 114, however tracking only one point is insufficient to define the orientation of the object, either an orientation vector or a plurality of tracking points must be defined. For the purposes of tracking movement of the object in response to received user commands a default start position of the object may be defined 704. The start position is defined by attributing positional coordinate data to the selected tracking point and the attributed positional coordinate data may be associated to a position on DEM 114—for this reason it is convenient to use the DEM 114 coordinate system to express object position variable data. The coordinate position data of the start positions of the vertices of the object are calculated with respect to the tracking point and associated to coordinate positions on DEM 114. In this manner the start position of the 3D object model is defined on DEM 114.

In embodiments where the object represents a land based vehicle the pitch and roll (ρ, θ) of the object may be determined by the disparity in altitude of the DEM terrain coordinate position of the projections of the object's vertices on the DEM 114—depending on how the axis are defined this may be equivalent to comparison of the disparity in z-coordinate values. The yaw angle (φ) may be derived from fixed geometric relationships between the object's vertices which are defined by the object model. In preferred embodiments the start position of the object's vertices are fixed within the virtual environment and coordinate position data may be attributed to the vertices 706. During playback of the sequential images user commands are received as generated by the user motion control apparatus 106 (FIG. 1) on the basis of which the game engine 116 calculates the new coordinate position data of the object 710 on the DEM 114. This may be achieved by first repositioning the tracking point and then calculating the positions of the vertices with respect to the tracking point using the defined object dimensions and the direction of motion, which may be inferred by comparison of the repositioned tracking point position with the previous tracking point position. This method of tracking the position of the tracking point and the direction of motion is applicable to objects whose direction of motion with respect to its vertices is fixed. As an example, consider a car, the car may only move along a fixed axis which is defined by the bonnet, therefore the direction of motion may be derived from the positions of the vertices of the bonnet. For objects whose direction of motion has a fixed orientation with respect to the object's vertices, knowledge of two quantities may determine the coordinate position of all vertices—tracking point coordinate position and direction of motion. Since the direction of motion may be calculated by comparing the current coordinate position of the tracking point with previous positions, only one point needs to be continuously tracked by the game engine 116—a defined tracking point. The game engine 116 will continue to reposition the object on the DEM 114 in accordance with received user commands until the simulation of the moving object in the virtual environment is complete 712 at which point the tracking is terminated 714.

In an alternative embodiment a plurality of points representing vertices of the object are selected and continuously tracked, and their position data related to position coordinates on DEM 114 by game engine 116. This embodiment is suitable for tracking the motion of objects whose direction of motion does not have a fixed orientation with respect to its vertices. This embodiment is also suited to tracking non-land based objects such as airplanes or helicopters, where the altitude of the positions of the DEM terrain projections of the vertices are not sufficient to determine roll and pitch (ρ, θ). In such embodiments it is preferable to continuously track the positions of each of a plurality of vertices in response to received user commands. By tracking the plurality of object vertices the orientation of the object is completely defined. As with the previous embodiment a default starting position is defined, received user commands are then processed by game engine 116 to reposition the plurality of vertices of the object to the new position in accordance with the received user commands. The minimum number of vertices required to track the motion of the object is dependent on the geometrical characteristics of the object. In preferred embodiments the minimum number of vertices are chosen and tracked such that the geometry of the object, as defined by the generated object model, may be derived from the plurality of tracked vertices. This is in contrast with the previous embodiment where the geometry of the object, as defined by the generated object model, is reconstructed from the position of the tracking point and the direction of motion. The current embodiment is a method of tracking the motion of the object which is equally suited to tracking any type of moving object, whereas the previous embodiment is more suited to tracking land-based moving objects where the roll and pitch may be inferred from the coordinate position data of the DEM terrain projections of the object's vertices. By tracking a plurality of object vertices the perspective of the object with respect to a current viewpoint may be inferred facilitating the process of overlaying the selected scenic image with the perspective image of the object. The perspective image of the object may only be inferred once the object model has been generated defining the geometry of the object.

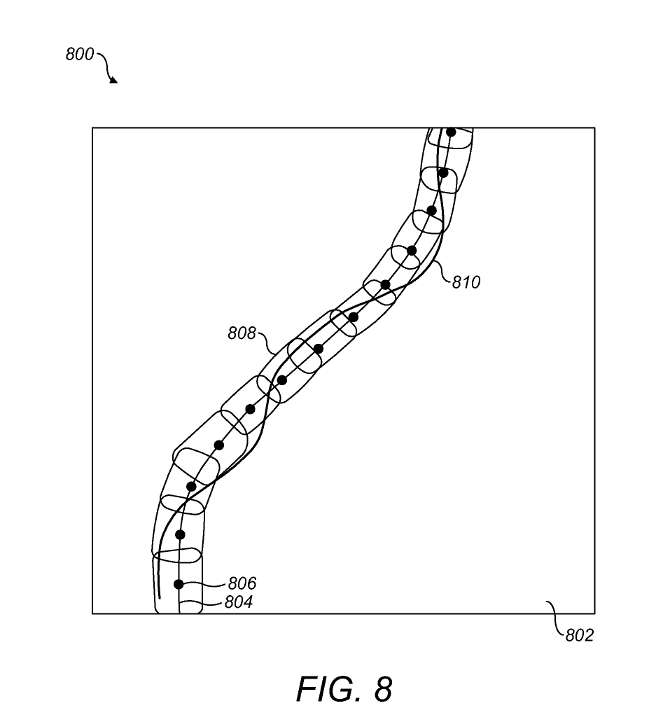

FIG. 8 is a plan view 800 of the DEM 802 depicting the capture path 804 of the image capture device 24, comprised of a plurality of capture positions (which are the viewpoint positions of the corresponding captured scenic images 112) 806. DEM terrain area 808 imaged by captured scenic images 112 is depicted as is the path of motion of the object 810. When the position of the object is contained within the DEM area 808 imaged by a scenic image, then the correct perspective image of the object is rendered, otherwise game engine 116 continues to track the position of the object.

It is envisaged that alternative methods of object tracking are employed utilising DEM 114 and fall within the scope of the present invention.

Image Rendering

According to an embodiment of the invention the current viewpoint is determined by a current viewpoint determinant on the basis of object position variable data. A scenic image is selected from the set of scenic images 112 on the basis of the determined viewpoint, which may be selected on the basis of proximity of the scenic image with the object position variable data in a preferred embodiment. The object is overlaid on the selected scenic image at the correct image position and with the correct perspective, using the relative position and orientation of the object with respect to the determined viewpoint position of the selected scenic image.

In accordance with an alternative embodiment of the present invention the current viewpoint is determined by the current viewpoint determinant on the basis of maintained current viewpoint variable data which is processed by CPU 124. In such embodiments in addition to tracking and maintaining object position variable data, current viewpoint variable data must also be maintained. A scenic image is selected on the basis of the determined viewpoint, determined by the current viewpoint determinant on the basis of the current viewpoint variable data. The algorithm employed by the current viewpoint determinant to determine the current viewpoint is not constant. The algorithm may be varied in relation to the current viewpoint variable data. The current viewpoint variable data is updated in response to received user commands hence the determined viewpoint is also updated in accordance with the received user commands. Different received user commands may result in different determined viewpoints and hence may result in different selected scenic images.

In preferred embodiments a first scenic image is selected, according to the determined viewpoint, from the set of sequentially captured scenic images 112. The current viewpoint determinant determines the current viewpoint on the basis of the defined default start coordinate position of the object. Preferably the selected first scenic image corresponds to the scenic image captured first by the image capture device 24. The current object position variable data, which in preferred embodiments may be the position coordinates associated with the vertices of the object model, together with the current viewpoint coordinate position is sufficient to generate the perspective image of the object as observed from the current viewpoint. The perspective image of the object is overlaid on the selected scenic image. A rendering application 120 is used to generate the correct perspective image of the object and to overlay the perspective image on the selected scenic image. The rendering application 120 may be a 3^{rd} party stand-alone application or may be a component of game engine 116.

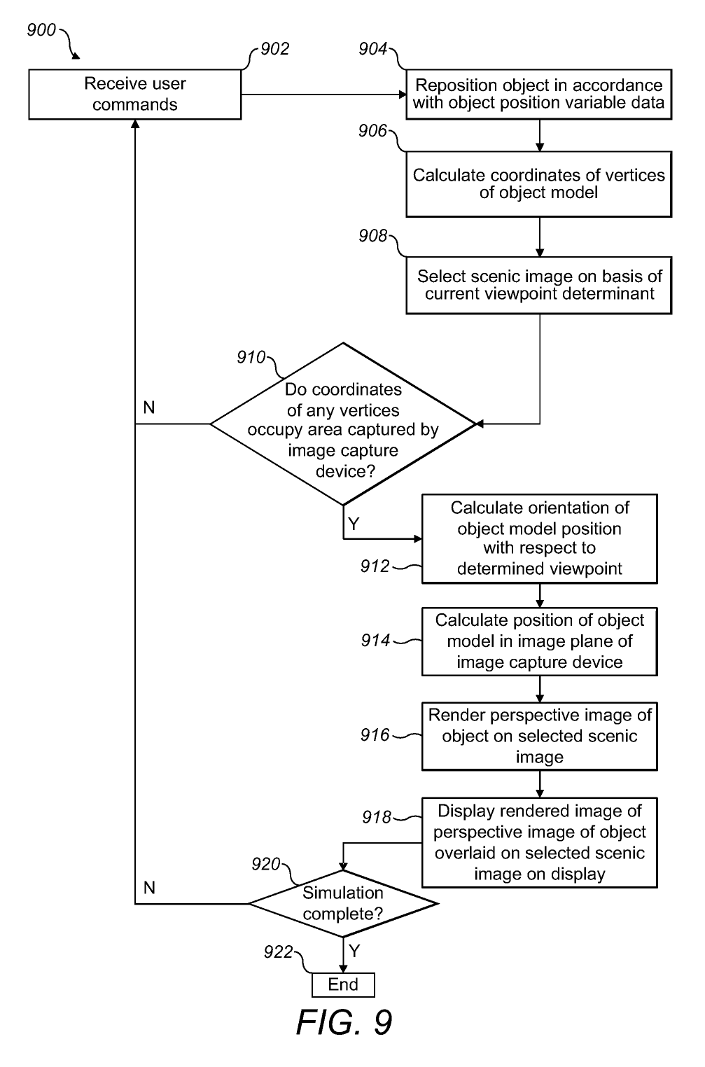

FIG. 9 illustrates a method of generating a single image in the sequence of generated images, for playback, representing movement of an object under user control within a virtual environment in accordance with an embodiment of the present invention. If the object model is at a default start position as described in the previous paragraph, then step 902 is skipped. Otherwise user commands 902 are generated by a user motion control apparatus 106. On the basis of generated user commands 902 game engine 116 calculates new object position variable data, in accordance with methods disclosed in the previous sections, and repositions the object on the basis of the newly calculated object position variable data 904. The coordinates of the vertices of the object model are calculated 906. The area of the DEM 114 occupied by the object model may be calculated by associating a position coordinate to each object model vertices. The current viewpoint determinant determines the current viewpoint on the basis of which the corresponding scenic image is selected 908 from the set of scenic images 112. In accordance with embodiments previously described the current viewpoint may be determined on the basis of the position coordinate values of the vertices of the object model. Alternatively the current viewpoint may be determined on the basis of current viewpoint variable data. The game engine 116 queries whether any of the object position variable data falls within the area imaged by the selected scenic image 910, which may be achieved by comparing coordinate position data of the object model and the imaged area of the selected scenic image. If the position of the object model does not fall within the area imaged by the selected scenic image then step 902 is repeated wherein new user commands are received and processed to reposition the object model in accordance with the new object position variable data 904. Once any portion of the object model position falls within the area imaged by the selected scenic image then the correct perspective image of the portion of the object model is generated, overlaid and rendered with the selected scenic image. The relative orientation and position of the object model with respect to the determined viewpoint position is calculated 912 by comparing the plurality of coordinates defining the object model's position with the viewpoint position coordinate. In those embodiments where only a portion of the object model occupies the area imaged by the selected scenic image, then only the orientation and position with respect to the selected viewpoint, of those portions occupying the area imaged by the selected scenic image are calculated. The other portions of the object model lie outside the area imaged by the selected scenic image. The user controlled motion of the object may therefore not be restricted to areas imaged by the scenic images 112. If the position of the object corresponds to an area imaged by a selected scenic image then the perspective image of the object model overlaid on the selected scenic image is rendered. Before the overlaid perspective image can be rendered the perspective image of the object model is placed at the correct image location within the selected scenic image, this may correspond to calculating the position of the object model in the image plane of the image capture device 914 positioned at the determined viewpoint position. Ray tracing methods may be used by game engine 116 or alternatively by rendering application 120. The perspective image of the object model, with respect to the determined viewpoint position of the selected scenic image, is overlaid on the selected scenic image and placed at the correct image position and rendered 916. In a preferred embodiment a video graphics card 122, containing a GPU 128 and a working memory 126 processes the relevant data to generate the rendered image. The rendered image is displayed on a suitable display device 104. Game engine 116 queries whether the simulation is complete 920, and if so the process is ended 922. If, however the simulation is not complete then the object is repositioned in accordance with received user commands 902 and the rendering process is conducted again for new object position variable data of the object.

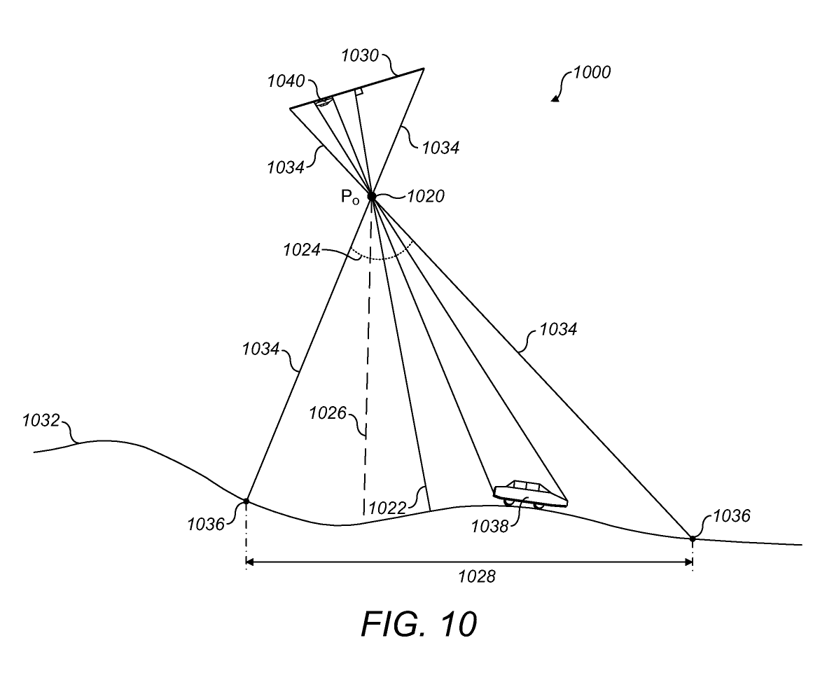

FIG. 10 illustrates the method 1000 of using ray tracing to generate the correct perspective image of the object, placed at the correct scenic image position. Viewpoint position 1020 of the selected scenic image is defined by coordinates P₀ (x, y, z, ρ, θ, φ), also defining the orientation of the optical axis 1022. The field of view 1024 of the image capture device 24 having captured the selected scenic image is a characteristic of the image capture 24 device used. The height of the viewpoint position 1026 (equivalent to the height of the image capture device 24) may be calculated in accordance with previously disclosed embodiments. For a selected scenic image captured at viewpoint position 1020, the DEM terrain area 1028 imaged by the selected scenic image may be found by backwards ray tracing extremum rays 1034 from the image capture device's image plane 1030, through the viewpoint position 1020, to DEM terrain 1032. The point of intersection of extremum rays 1034 with DEM points 1036 define the boundary of the terrain area imaged by the selected scenic image and a coordinate value may be attributed to points of intersection 1036. The position of the object model 1038 and its vertices are known by tracking its position on the basis of received user commands and with respect to DEM 1032. Rays are traced from the position of the object model's vertices through the viewpoint position 1020 to the image capture device's image plane 1030. The traced rays define an area on the image plane 1030 occupied by the perspective image 1040 of the object. The ray tracing is processed by the GPU 128 of the video graphics card 122 in embodiments where a video graphics card 122 is available. In certain embodiments a plurality of rays may be traced for a plurality of selected object model points. The ray tracing method results in the correct perspective image 1040 of the object, as would be observed from determined viewpoint position 1020, placed at the correct position in image plane 1030. The perspective image 1040 is overlaid on the selected scenic image captured from the determined viewpoint 1020 position. In a preferred embodiment perspective image 1040 is generated directly on the selected scenic image, rather than a two-stage process of generating perspective image 1040 and then overlaying perspective image 1040 on the selected scenic image. The rendered image may be displayed on display apparatus 104 and is one image in the generated sequence of sequential images. Subsequent sequential images are generated on the basis of object position variable data and the selected scenic image, and played back on display 104.

### Playback

The generated sequential images represent an object under user control and in preferred embodiments simulate motion of a user controlled object within a virtual environment. The rate at which the generated sequential images are played back on display apparatus 104 influence the user's impression of speed. The faster the rate of sequential image playback, the greater the impression of speed conveyed to a user viewing the generated sequential images on display 104. Similarly the slower the rate of playback the slower the speed of the object appears to a user viewing the sequential images on display 104. The spacing of the viewpoints, corresponding to positions of scenic image capture, is substantially constant in preferred embodiments. The spacing of adjacent viewpoints and the minimum image rate of the generated sequential images as disclosed in the section titled “Data Capture” place constraints on the minimum speed of the object. The minimum speed component of the object in the direction of displacement of the viewpoint position is constrained by the minimum image rate and viewpoint spacing. In preferred embodiments it is envisaged that the direction of motion of the object is not always in the direction of viewpoint displacement. However, the moving object will have a speed component in the direction of viewpoint displacement which varies with the minimum image rate and viewpoint spacing. The moving object has a minimum speed component in the direction of viewpoint displacement consistent with the minimum image rate, which is satisfied for the generated sequential images. A notable exception arises when the object is at rest, in which case the image rate may be zero, however the frame rate continues at the desired rate. When the object is in motion it travels at a speed such that the speed component in the direction of viewpoint displacement is at the very least consistent with the minimum image rate. Should the condition not be satisfied then the transition between adjacent generated sequential images and accordingly the simulation of motion of the object in the virtual environment will not appear smooth. Similarly when the speed component, as controlled by the received user commands generated from user motion control apparatus 106, in the direction of viewpoint displacement of the object is greater than the minimum value, then the image rate is adjusted accordingly. In such embodiments the image rate is preferably equal to or greater than the minimum image rate, which is preferably at least 14 Hz in preferred embodiments.

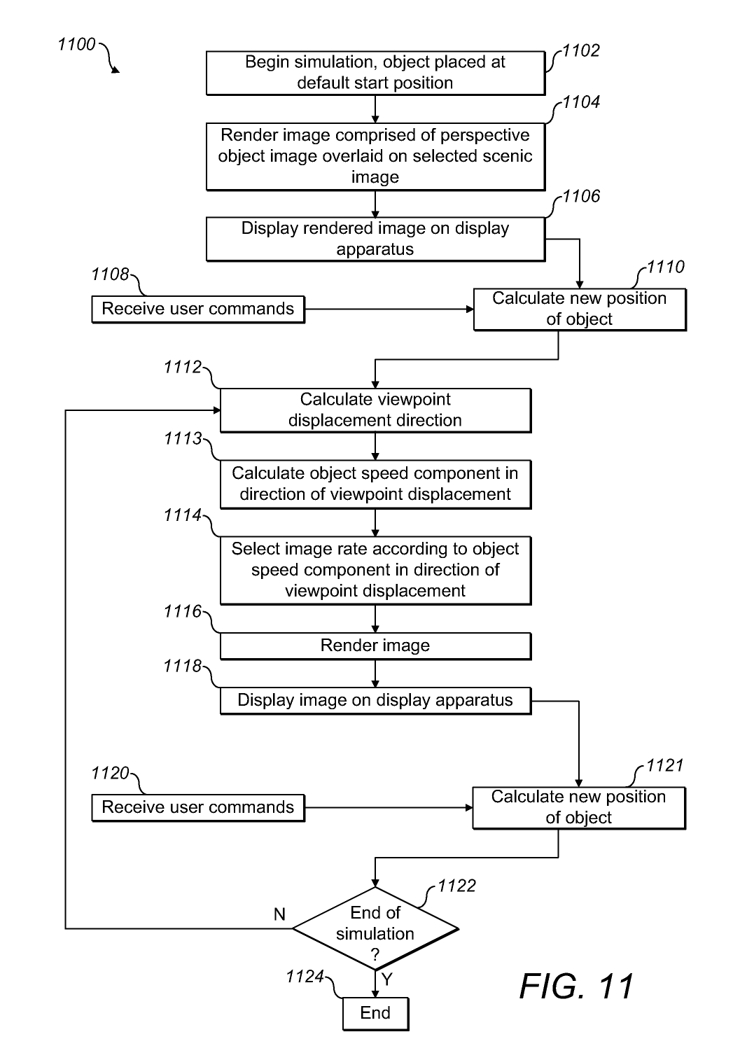

FIG. 11 is a flow chart of a method, in accordance with an embodiment of the present invention, for determining and selecting the image rate during playback of the generated sequential images. The object is placed at the default start position 1102 and the overlaid image comprised of object and scenic image is rendered 1104 and displayed 1106. User commands 1108, generated by user motion control apparatus 106, are received and the position of the object calculated 1110. The direction of displacement of the viewpoint is calculated 1112 by comparison with the next viewpoint position in the scenic image sequence. The object's speed component in the direction of viewpoint displacement is calculated 1113. The velocity of the object model is defined on the basis of the received user commands 1108. The image rate is selected on the basis of the object's speed component in the direction of viewpoint displacement 1114. The scenic image with the overlaid perspective image of the object is rendered 1116 and displayed 1118. On the basis of new received user commands 1120 the computer game engine 116 calculates the new position of the object 1121. The game engine 116 queries whether the simulation has come to an end 1122, and if so the simulation is ended 1124. Otherwise the process returns to 1112 wherein the direction of viewpoint displacement is calculated for the selected scenic image.

### Further Embodiments

In accordance with the current invention a plurality of further embodiments are envisaged. The skilled reader will recognize that a plurality of additional graphical effects are possible in conjunction with the previously disclosed embodiments and fall within the scope of the invention.

A notable further embodiment is lighting effects. Shading and lighting of the overlaid perspective image of the object are preferably consistent with the lighting of the captured scenic image on which it is overlaid. In a preferred embodiment the position of the natural lighting source (which is likely to be the sun for scenic images captured outdoors) may be recorded with the captured scenic images and stored on storage media 110. The position of the lighting source may then be used by game engine 116, or alternatively by 3^{rd} party stand-alone rendering application 120, and preferably processed by the GPU 128 of the video graphics card 122, to generate the correct perspective of the object with the correct lighting and shading by simulating the natural lighting source during rendering. In alternative embodiments the position of the natural lighting source may be inferred from the captured scenic images 112 and used by game engine 116 (or stand-alone rendering application 120) during rendering to generate the correct lighting and shadows consistent with the lighting and shading of the scenic images 112. A plurality of lighting effects may be simulated, such as reflectance of the surfaces of the object as well as texture effects. The level of detail achieved is conditioned by the complexity of the rendering function of the game engine 116 or the complexity of the stand alone 3^{rd} party rendering application used, as well as the processing capabilities of video graphics card 122.

Depth of field effects may be used to increase the realism of the rendered sequential images, whereby image objects appearing far from the object are blurred slightly.

In alternative embodiments motion blurring (also referred to as spatial anti-aliasing) effects may be incorporated in the generated sequential images. This increases the realism of the conveyed impression of motion of the object within the generated sequential images, wherein peripheral scenic image features may be blurred to simulate speed. Additionally copies of the moving object may be left in the object's wake, becoming increasingly less distinct and intense as the object moves further away. The amount of motion blurring depends on the speed of the moving object, and the speed of the moving object is conveyed by varying the image rate. Hence the amount of motion blurring may be determined and regulated by the image rate during playback.

Inertial effects may also be simulated. In certain embodiments this may be achieved by simulation of the image capture device 24 varying its zoom state, achieved by varying the apparent distance of the determined viewpoint from the object in response to an acceleration of the object and by varying the apparent field of view of the displayed sequential image. A positive acceleration could be simulated by the image capture device 24 zooming out. In certain embodiments this may be achieved by displaying a reduced portion of the generated sequential image initially, such that as the object accelerates the field of view of the generated sequential image is increased, the apparent distance of the determined viewpoint from the object increased and the size of the perspective image of the object decreased, resulting in the impression that the object is accelerating. Similarly a deceleration of the object may be simulated by reducing the apparent distance between the determined viewpoint and the perspective object image by reducing the apparent field of view of the rendered sequential image and resizing the perspective image proportionately to the decrease in field of view.

In alternative embodiments it is envisaged that one or more objects are overlaid on selected scenic images in addition to the perspective object image and rendered to generate sequential images. The one or more objects may interact with each other as defined by the physics engine (also referred to as collision detection) component of the game engine 116. Such objects may include other moving objects not directly controlled by a user, instead such non-user controlled moving objects are controlled by an artificial intelligence component of game engine 116.

In alternative embodiments of the present invention the object model may be replaced by a sprite. The sprite is an image of the object from a fixed perspective which may be overlaid on the selected scenic image to generate a sequential image. This technique of rendering is often referred to as billboarding. The perspective of the overlaid sprite is chosen to be consistent with the perspective of the selected scenic image.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of generating sequential images representing an object under user control within a virtual environment, the method comprising accessing a set of scenic images which each represent at least part of said virtual environment as viewed from known viewpoints, and during sequential image generation:
receiving user commands;
maintaining object position variable data representing a current object position within said virtual environment, which is updated in response to said user commands;
selecting scenic images to be accessed according to a current viewpoint determinant;
overlaying a generated object image onto a selected scenic image according to the current object position.

2. The method according to claim 1, comprising maintaining current viewpoint variable data, which is updated in response to said user commands, said viewpoint determinant being based upon said current viewpoint variable data.

3. The method according to claim 1, comprising generating said object image based on a polygonal model.

4. The method according to claim 1, comprising generating said object image as a sprite.

5. The method according to claim 1, wherein said scenic images comprise photographic scenic images.

6. The method according to claim 1, wherein said scenic images which are accessed comprise a set of sequentially related scenic images which are related by a path of travel.

7. The method according to claim 6, wherein said path of travel is non-linear.

8. The method according to claim 6, wherein said path of travel is defined by viewpoint location data associated with said scenic image.

9. The method according to claim 6, wherein said object has movement within at least one direction different to said path of travel.

10. The method according to claim 9, wherein said object is moved under user control within at least one direction different to said path of travel.

11. The method according to claim 9, wherein said object is moved under control of a control program defining an object surface which has a variation in height different to said path of travel.

12. The method according to claim 11, wherein said object surface comprises a definition of a surface on which said object is defined to travel.

13. The method according to claim 12, when dependent on at least claim 9, wherein said object is moved under user control within at least one direction perpendicular to said path of travel and across said surface on which said object is defined to travel.

14. The method according to claim 1, wherein each said scenic image has an associated viewpoint.

15. A method of capturing sequential images for use in the subsequent generation of images representing an object under user control within a virtual environment, the method comprising capturing a set of scenic images which each represent at least part of said virtual environment as viewed from known viewpoints, and defining an object control process for use during sequential image generation, the defined object control process comprising:
a function for receiving user commands;
a function for maintaining object position variable data representing a current object position within said virtual environment, which is updated in response to said user commands;
a function for selecting scenic images to be accessed according to a current viewpoint determinant; and
a function for overlaying a generated object image onto a selected scenic image according to the current object position.

16. A computer program product comprising a non-transitory computer-readable storage medium having computer readable instructions stored thereon, the computer readable instructions being executable by a computerized device to cause the computerized device to perform a method for generating sequential images representing an object under user control within a virtual environment, the method comprising accessing a set of scenic images which each represent at least part of said virtual environment as viewed from known viewpoints, and during sequential image generation:
receiving user commands;
maintaining object position variable data representing a current object position within said virtual environment, which is updated in response to said user commands;
selecting scenic images to be accessed according to a current viewpoint determinant;
overlaying a generated object image onto a selected scenic image according to the current object position.
